(19) United States
(12) Patent Application Publication
(10) Pub. No.: US 2005/0159330 A1
(43) Pub. Date: Jul. 21, 2005

(54) Detergent composition

(75) Inventors: Pankaj Chandrakant Shah, Mumbai (IN); Ananthasubramanian Sivakumar, Mumbai (IN)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Unilever Home & Personal Care USA, Division of Conopco, Inc.

(21) Appl. No.: 11/036,898

(22) Filed: Jan. 14, 2005

(30) Foreign Application Priority Data
Jan. 16, 2004 (IN) 0046/MUM/2004

(51) Int. Cl. C11D 1/00

(52) U.S. Cl. 510/504

(57) ABSTRACT

A cleansing composition capable of enhancing deposition of benefit agent comprising: iv. a functional oil-in-water emulsion comprising 0.1% to 5% by weight benefit agent solubilised/dispersed in an oil and emulsified in water using a cationic emulsifier having an HLB greater than 8 such that the ratio of oil:cationic emulsifier is in the range 20:1 to 1:1; v. a detergent active composition comprising 5% to 80% detergent active; and vi. a cationic polymer.

The present invention relates to a cleansing composition comprising a novel system for delivery of benefit agents. In particular, the invention relates to a detergent composition provided with a system for enhancing the deposition of benefit agents such as sunscreens, perfume, emollients, humectants onto skin, hair or other substrates.

Delivery and deposition of functional ingredients through cleansing compositions which involve the washing off of the product without providing adequate time for delivery has been a problem. Various formulation modifications have been suggested to enhance deposition and delivery of functional ingredients through cleansing compositions.

The use of deposition polymers such as cationic polymers to enhance deposition of benefit agents in soaps and shampoos are well known in the art. For example in liquid cleansers, cationic hydrophilic polymers such as Polymer JR^{RTM} from Americhol or Jaguar^{RTM} from Rhone Poulenc have been used to enhance delivery of benefit agents (WO 94/03152 and WO 94/03151).

WO98/42815 (Unilever, 1998) discloses a method for enhancing deposition of benefit agent from a bar composition where an adjuvant composition is prepared separately having the benefit agent, cationic deposition polymer and water soluble/dispersible filler and mixing it into the base composition comprising a surfactant system. Using the method it is possible to formulate a bar having enhanced deposition of benefit agent without compromising processing or consumer attributes.

U.S. Pat. No. 3,761,418 (P&G, 1973), discloses use of cationic polymers in detergent compositions to enhance the deposition and retention on the substrate of water-insoluble particulate substances, such as antimicrobial agents.

U.S. Pat. No. 3,814,698 (Ferrara et al, 1974) discloses soap bars containing high levels of oils. However, such soap bars tend to reduce lather performance, are soft and become softer with increased use, which makes the bars difficult to use and undesirable to handle. Besides the above undesirable properties, soap bars containing high level of oils are soft and mushy, resulting in difficulties in processing through conventional bar extrusion equipment.

U.S. Pat. No. 6,057,275 (Unilever, 2000) discloses that cationic polymer of minimum charge density level can be used to enhance deposition of oils/emollients in bars comprising relatively large amount of hydrophilic structurant. The specific ratio of the cationic to surfactant compounds is important to enhance deposition.

Cleansing compositions are formulated as both solid and non-solid forms. In the various forms like bars, liquids, gels, in general, enhanced deposition of functional ingredients through these formulations would be highly beneficial.

Surprisingly, it has now been found that enhanced deposition of benefit agents can be obtained from compositions comprising a ‘functional oil-in-water emulsion’, a detergent active composition and a cationic polymer. The functional oil-in-water emulsion is formulated by solubilising /dispersing the desired benefit agent in oil and emulsifying the same in water using a cationic emulsifier in specific ratios.

It has been found that there is synergy in the combination of the ‘functional oil-in-water emulsion’ comprising the benefit agent and the presence of the cationic polymer in the composition of the invention that gives the superior deposition. None of the above mentioned prior art relates to enhancing deposition of the benefit agent by the combination of benefit agent present in the functional emulsion, and the incorporation of the cationic polymer in the composition.

WO98/42815 discloses that when cationic polymers have been used to enhance deposition of oil, deposition has been small and not sufficient for perceivable skin effect. This is because benefit agent/oil has never been physically separated from the rest of the composition prior to final formation of the bar. When benefit agent and cationic polymer are separately formed and later mixed with other bar components, enhanced deposition is obtained.

It has now been found that a combination of dispersing /solubilising the benefit agent in the functional oil-in-water emulsion and the cationic polymer present in the detergent composition gives superior deposition.

It is thus an object of the invention to be able to provide for a cleansing composition that gives vastly enhanced deposition of benefit agents from a wash off product.

It is another object of the invention to be able to provide for enhanced deposition efficiency of benefit agent on to substrates like skin and hair from a wash-off composition, thereby requiring minimal amount of the benefit agent to be added to the composition thereby minimizing cost.

It is yet another object of the invention to be able to provide for a novel process for preparation of a cleansing composition that provides enhanced deposition of benefit agents on to substrates like skin and hair.

In one aspect the present invention provides for a cleansing composition capable of enhancing deposition of benefit agent comprising:
i. a functional oil-in-water emulsion comprising 0.1% to 5% by weight benefit agent solubilised/dispersed in an oil and emulsified in water using a cationic emulsifier having an HLB greater than 8 such that the ratio of oil:emulsifier is in the range 20:1 to 1:1;
ii. a detergent active composition comprising 5% to 80% detergent active; and
iii a cationic polymer.

Another aspect of the invention provides for a process for the preparation of a cleansing composition for enhanced delivery of benefit agents comprising the steps of:
i. dispersing/dissolving the benefit agent in the oil by mixing;
ii. preparing a functional oil-in-water emulsion by mixing the product of step (i) in water along with a cationic emulsifier; and
iii. mixing the functional oil-in-water emulsion with other ingredients to prepare a composition comprising the functional oil-in-water emulsion, detergent active and cationic polymer.

All parts and percentages mentioned herein are by weight of the composition unless otherwise specified.

The invention relates to a cleansing composition and process to prepare the same that provides for enhanced deposition of benefit agents including sunscreens, perfumes, emollients, anitmicrobial agents, humectants on to hair, skin or other substrates.

One aspect of the invention provides for a composition that comprises a functional oil-in-water emulsion, a detergent active composition and a cationic polymer. The functional water-in-oil emulsion comprises the benefit agent to be delivered to the substrate to be solubilised/dispersed in an oil, and the dispersion/solution of benefit agent in oil is emulsified in water using a cationic emulsifier.

The benefit agents that can deposited on to substrates such as skin and hair using the cleansing composition of the present invention include sunscreens, perfumes, emollients, anitmicrobial agents, humectants, oils, or moisturizing agents. The benefit agent is typically present in an amount of 0.1% to 5%, preferably from 0.05% to 2.5%, more preferably from 0.1% to 1.7% by weight of the composition.

The benefit agent may be solubilized in the oil or may be dispersed in the oil. The term ‘oil’ as described for the purposes of the present invention includes the class of hydrophobic liquid compounds described below.

The oil is a hydrophobic carrier which can be preferably selected from variety of oils including mineral oils, vegetable oils, silicone oils or synthetic oils. The oil/hydrophobic carrier may be volatile or non-volatile. Preferably, the non-volatile oil comprises compounds which contain less than 50% unsaturation. The non volatile oil does not evaporate from the skin or hair. A non volatile oil phase preferably has a boiling point at atmospheric pressure of greater than about 250° C.

Exemplary non-volatile silicone compounds include a polyalkyl siloxane, a polyaryl siloxane or a polyalkylaryl siloxane. Mixtures of these non-volatile silicone compounds also are useful. The non-volatile oil also can comprise a non-volatile hydrocarbon compound, such as mineral oil, petrolatum, sunflower seed oil, canola oil or mixtures thereof.

Other exemplary non-volatile hydrocarbon compounds that can be incorporated into the oil phase include, but are not limited to, a branched 1-decene oligomer, such as 1-decene dimer or a polydecene. The oil also optionally can comprise (1) an oil, such as jojoba oil, wheat germ oil or purcellin oil; or (2) a water insoluble emollient, such as, for example, an ester having at least about 10 carbon atoms, and preferably about 10 to about 32 carbon atoms.

The oil can also be chosen from suitable esters including those comprising an aliphatic alcohol having about eight to about twenty carbon atoms and an aliphatic or aromatic carboxylic acid including from two to about twelve carbon atoms, or conversely an aliphatic alcohol having two to about twelve carbon atoms with an aliphatic or aromatic carboxylic acid including about eight to about twenty carbon atoms. The ester is either straight chained or branched.

Preferably, the ester has a molecular wt. of less than about 500. Suitable esters therefore include, for example, but are not limited to: (a) aliphatic monohydric alcohol esters such as isopropyl isostearate, cetyl acetate, cetyl stearate; myristyl propionate, isopropyl myristate, isopropyl palmitate, cetyl acetate, cetyl propionate, cetyl stearate, (b) aliphatic di- and tri-esters of polycarboxylic acids, (e.g., diisopropyl adipate); (c) aliphatic polyhydric alcohol esters (e.g., propylene glycol dipelargonate); and (d) aliphatic esters of aromatic acids, (e.g., C 12-C₁₋₅ alcohol esters of benzoic acid).

The most preferred oils for use in the invention include isopropyl myristate, isopropyl palmitate, structured mineral oil and silicone oil. The oil is preferably present in an amount of 0.5% to 5% by weight of the composition.

The cationic emulsifier includes substances from the class of surfactants which have an HLB greater than 8, more preferably an HLB value in the range of 13 to 18. Examples of suitable cationic surfactants can be found among quaternary ammonium salts having one or two alkyl or aralkyl groups of from 8 to 20 carbon atoms and two or three small aliphatic (e.g. methyl) groups e.g. alkyl (C₈ to C₁₈) trimethyl ammonium halide (chloride or bromide), lauryl dimethyl hydroxyethyl ammonium chloride, oleyl bis(2-hydroxyethyl)methyl ammonium chloride, penta methyl tallow alkyl-1,3-propane diammonium dichloride.

The cationic emulsifier is preferably present in an amount of 0.05% to 2.5% by weight of the composition. The ratio of oil:emulsifier in the functional oil-in-water emulsion of the invention is in the range of 20:1 to 1:1, more preferably in the range of 10:1 to 1:1.

The composition of the invention comprises a cationic polymer. The cationic polymer is preferably selected from poly(diallyl dimethyl ammonium chloride), poly(dimethyl amino ethyl acrylate)-quaternized {DMAEA quat}, Poly (dimethyl amino ethyl methacrylate)-quaternized {DMAEM quat}, poly(methacrylamido propyl trimethyl ammonium chloride) {MAPTAC}, copolymers of DMAEA-quat or DMAEM-quat or MAPTAC with vinyl pyrrolidone or acrylamide, and co-polymer of vinylimidazole-quat with vinyl pyrrolidone or cationized starch.

The cationic polymer is more preferably selected from poly(diallyl dimethyl ammonium chloride), poly(dimethyl amino ethyl acrylate)-quaternized {DMAEA quat}, poly (dimethyl amino ethyl methacrylate)-quaternized {DMAEM quat}, or poly(methacrylamido propyl trimethyl ammonium chloride) {MAPTAC}. The cationic polymer preferably has a molecular weight in the range of 40 to 5000 kg/mole, more preferably in the range of 200-500 kg/mole.

The cationic polymer preferably has a charge density greater than 1 meq/g more preferably in the range of 5 to 6 mEq/g.

The cationic polymer is preferably present in an amount of 0.75% to 4.0%, more preferably in an amount of 1% to 2.7% by weight of the composition.

The cleansing system of the composition comprises a detergent active composition comprising 5% to 80% detergent active. The detergent active may be chosen from soap or non-soap surfactants.

The term “soap” denotes salts of carboxylic fatty acids such as for example sodium, zinc, potassium, magnesium, alkyl ammonium and aluminium salts of fatty acids. The soap may be derived from any of the triglycerides conventionally used in soap manufacture—consequently the carboxylate anions in the soap may typically contain from 8 to 22 carbon atoms.

The soap may typically be obtained by saponifying a fat and/or a fatty acid. The fats or oils generally used in soap manufacture may be such as tallow, tallow stearines, palm oil, palm stearines, soya bean oil, fish oil, castor oil, rice bran oil, sunflower oil, coconut oil, babassu oil, palm kernel oil, and others. In the above process the fatty acids are derived from oils/fats selected from coconut, rice bran, groundnut, tallow, palm, palm kernel, cotton seed, soyabean, castor etc.

The fatty acid soaps can also be synthetically prepared (e.g. by the oxidation of petroleum or by the hydrogenation of carbon monoxide by the Fischer-Tropsch process). Resin acids, such as those present in tall oil, may be used. Naphthenic acids are also suitable.

Tallow fatty acids can be derived from various animal sources and generally comprise about 1% to 8% myristic acid, about 21% to 32% palmitic acid, about 14% to 31% stearic acid, about 0 to 4% palmitoleic acid, about 36% to 50% oleic acid and about 0 to 5% linoleic acid. A typical distribution is 2.5% myristic acid, 29% palmitic acid, 23% stearic acid, 2% palmitoleic acid, 41.5% oleic acid, and 3% linoleic acid. Other similar mixtures, such as those from palm oil and those derived from various animal tallow and lard are also included.

Coconut oil refers to fatty acid mixtures having an approximate carbon chain length distribution of 8% C₈, 7% C₁₀, 48% C₁₂, 17% C₁₄, 8% C₁₆, 2% C₁₈, 7% oleic and 2% linoleic acids (the first six fatty acids listed being saturated). Other sources having similar carbon chain length distributions, such as palm kernel oil and babassu kernel oil, are included within the term coconut oil.

A typical fatty acid blend consisted of 5 to 30% coconut fatty acids and 70 to 95% fatty acids ex hardened rice bran oil. Fatty acids derived from other suitable oils/fats such as groundnut, soybean, tallow, palm, palm kernel, etc. may also be used in other desired proportions.

Non-soap detergent active compounds maybe chosen from anionic, cationic, nonionic, amphoteric or zwitterionic surfactant classes. A suitable class of anionic surfactants is water-soluble salts of organic sulphuric acid mono-esters and sulphonic acids having in the molecular structure a branched or straight chain alkyl group containing 8 to 22 C atoms or an alkylaryl group containing 6 to 20 C atoms in the alkyl part.

Examples of such anionic surfactants are water-soluble salts of:
long chain (i.e. 8 to 22 C atom) alcohol sulphates (hereinafter referred to as PAS), especially those obtained by sulphating the fatty alcohols produced from tallow or coconut oil or the synthetic alcohols derived from petroleum;
alkylbenzene-sulphonates, such as those in which the alkyl group contains from 6 to 20 carbon atoms;
secondary alkanesulphonates.

Also suitable are the salts of:
alkylglyceryl ether sulphates, especially of the ethers of fatty alcohols derived from tallow and coconut oil;
fatty acid monoglyceride sulphates;
sulphates of ethoxylated aliphatic alcohols containing 1-12 ethyleneoxy groups;
alkylphenol ethylenoxy-ether sulphates with from 1 to 8 ethyleneoxy units per molecule and in which the alkyl groups contain from 4 to 14 carbon atoms;
the reaction product of fatty acids esterified with isethionic acid and neutralised with alkali.

A suitable class of nonionic surfactants can be broadly described as compounds produced by the condensation of simple alkylene oxides, which are hydrophilic in nature, with an aliphatic or alkyl-aromatic hydrophobic compound having a reactive hydrogen atom. The length of the hydrophilic or polyoxyalkylene chain which is attached to any particular hydrophobic group can be readily adjusted to yield a compound having the desired balance between hydrophilic and hydrophobic elements. This enables the choice of nonionic surfactants with the right HLB.

Particular examples include:
the condensation products of aliphatic alcohols having from 8 to 22 carbon atoms in either straight or branched chain configuration with ethylene oxide, such as a coconut alcohol/ethylene oxide condensates having from 2 to 15 moles of ethylene oxide per mole of coconut alcohol;
condensates of alkylphenols having C₆-C₁₅ alkyl groups with 5 to 25 moles of ethylene oxide per mole of alkylphenol;
condensates of the reaction product of ethylene-diamine and propylene oxide with ethylene oxide, the condensates containing from 40% to 80% of ethyleneoxy groups by weight and having a molecular weight of from 5,000 to 11,000.

Other suitable classes of nonionic surfactants are:
alkyl polyglycosides, which are condensation products of long chain aliphatic alcohols and saccharides;
tertiary amine oxides of structure RRRN0, where one R is an alkyl group of 8 to 20 carbon atoms and the other R's are each alkyl or hydroxyalkyl groups of 1 to 3 carbon atoms, e.g. dimethyldodecylamine oxide;
tertiary phosphine oxides of structure RRRP0, where one R is an alkyl group of 8 to 20 carbon atoms and the other R's are each alkyl or hydroxyalkyl groups of 1 to 3 carbon atoms, for instance dimethyl-dodecylphosphine oxide;
dialkyl sulphoxides of structure RRS0 where one R is an alkyl group of from 10 to 18 carbon atoms and the other is methyl or ethyl, for instance methyl-tetradecyl sulphoxide;
fatty acid alkylolamides, such as the ethanol amides;
alkylene oxide condensates of fatty acid alkylolamides; and
alkyl mercaptans.

A specific group of surfactants are the tertiary amines obtained by condensation of ethylene and/or propylene oxide with long chain aliphatic amines. The compounds behave like nonionic surfactants in alkaline medium, and like cationic surfactants in acid medium.

It is possible optionally to include amphoteric, cationic or zwitterionic surfactants in the compositions according to the invention.

Suitable amphoteric surfactant compounds that optionally can be employed are derivatives of aliphatic secondary and tertiary amines containing an alkyl group of 8 to 18 carbon atoms and an aliphatic radical substituted by an anionic water-solubilizing group, for instance sodium 3-dodecylamino-propionate, sodium 3-dodecylaminopropane sulphonate and sodium N-2-hydroxydodecyl-N-methyltaurate.

Examples of suitable cationic surfactants can be found among quaternary ammonium salts having one or two alkyl or aralkyl groups of from 8 to 20 carbon atoms and two or three small aliphatic (e.g. methyl) groups, for instance cetyltrimethylammonium halide.

Examples of suitable zwitterionic surfactants can be found among derivatives of aliphatic quaternary ammonium, sulphonium and phosphonium compounds having an aliphatic group of from 8 to 18 carbon atoms and an aliphatic group substituted by an anionic water-solubilising group, for instance 3-(N,N-dimethyl-N-hexadecylammonium)-propane-1-sulphonate betaine, 3-(dodecylmethyl-sulphonium)-propane-1-sulphonate betaine and 3-(cetylmethyl-phosphonium)-ethanesulphonate betaine.

Other well known betaines are the alkylamidopropyl betaines e.g. those wherein the alkylamido group is derived from coconut oil fatty acids.

Further examples of suitable surfactants are compounds commonly used as surface-active agents given in the well-known textbooks: “Surface Active Agents” Vol. 1, by Schwartz & Perry, Interscience 1949; “Surface Active Agents” Vol. 2 by Schwartz, Perry & Berch, Interscience 1958; the current edition of “McCutcheon's Emulsifiers and Detergents” published by Manufacturing Confectioners Company; “Tenside-Taschenbuch”, H. Stache, 2nd Edn., Carl Hauser Verlag, 1981.

The cleaning composition of the invention may comprise optional ingredients, such as for example a thickener. The thickener is preferably a fatty alcohol with carbon chain length of 10 to 18, more preferably with carbon chain length of 16 to 18. The thickener is preferably present in an amount of not more than 5% of the cleaning composition.

The detergent active composition may comprise additional benefit agents such as for example antioxidants, binders, biological additives, buffering agents, colorants, thickeners, polymers, astringents, fragrance, humectants, opacifying agents, pH adjusters, preservatives, natural extracts, essential oils, skin sensates, skin soothing agents, and skin healing agents.

Another aspect of the invention provides for a process for the preparation of a cleansing composition for enhanced delivery of benefit agents comprising the steps of
i. dispersing/dissolving the benefit agent in the oil by mixing;
ii. preparing a functional oil-in-water emulsion by mixing the product of step (i) in water along with a cationic emulsifier; and
iii. mixing the functional oil-in-water emulsion with other ingredients to prepare a composition comprising the functional oil-in-water emulsion, detergent active and cationic polymer.

The cationic polymer may be mixed with the functional oil-in-water emulsion, or may be mixed with the detergent active composition. It is also possible that part of the cationic polymer is mixed with the functional oil-in-water emulsion and a part is mixed with the detergent active composition. It is also possible that the detergent active composition is first mixed with the functional oil-in-water emulsion and after preparing a mixture of the two, the cationic polymer is then post-dosed and mixed with the mixture prepared.

When a thickener is present in the composition it is preferably added to the functional oil-in-water emulsion.

### EXAMPLES

The invention will now be further demonstrated by way of the following non-limiting examples.

### Comparative Example A

A detergent active composition with the ingredients given in Table 1 was prepared. The composition was formulated with 0.3% Triclosan as the benefit agent, which is desired to be deposited on the skin. The ingredients were all taken in a vessel at 75° C. and mixed together to form a homogeneous mass, and then cooled to ambient temperature.

TABLE 1

| Ingredients | Parts by weight |
|---|---|
| Sodium Lauryl Ethoxylate Sulphate | 11.11 |
| Coco Amido Propyl Betaine | 4.78 |
| Coco Mono Ethanol Amide | 2.00 |
| Propylene Glycol | 2.00 |
| Sodium Carboxymethyl cellulose | 0.70 |
| Stearic Acid | 2.85 |
| Other minor benefit agents | 2.51 |
| Triclosan - Benefit agent desired to be | 0.3 |
| deposited on skin | |
| Water | 73.75 |

### Comparative Example B

0.3 parts benefit agent Triclosan was dissolved in 2.5 parts an oil i.e. isopropyl myristate. This mixture was then mixed with the composition of Table 1 to which 0.3 parts Triclosan and 2.5 parts water were not added.

### Comparative Example C

An emulsion containing 2.5 parts of isopropyl myristate, 2.0 parts of cetyl alcohol, 1.0 parts of cationic emulsifier i.e cetyl trimethyl ammonium chloride, 4.2 parts water and 0.3 parts of Triclosan (benefit agent) was prepared. 10 parts of the emulsion based on the formulation was added to the composition of Table 1 to which 9.7 parts water and 0.3 parts Triclosan were not added.

### Comparative Example D

2.5 parts by weight of isopropyl myristate containing 0.3 parts of benefit agent and 2.5 parts of a cationic polymer i.e. poly(diallyl dimethyl ammonium chloride) were added and mixed with the detergent composition of Table 1 to which 5 parts of water and the 0.3 parts Triclosan were not added.

### Comparative Example E

A composition as per Comparative Example A is prepared, except that 1 part water was not added. 1 part by weight of cationic emulsifier i.e. cetyl trimethyl ammonium chloride was added to the composition and mixed.

### Example 1

A composition as per Table 1 was prepared except that the benefit agent Triclosan and 12.2 parts of water were not added. To this was added 2.5 parts of poly(diallyl dimethyl ammonium chloride). An emulsion containing 2.5 parts of isopropyl myristate, 2.0 parts of cetyl alcohol, 1.0 parts of cationic emulsifier, 4.2 parts water and 0.3 parts of triclosan (benefit agent) was prepared and mixed with the composition already prepared.

The compositions viz. comparative examples A to E and example 1 were used in a wash study to determine the deposition of the benefit agent Triclosan on the skin. The procedure involved washing a 7 cm area of the forearm of volunteers with 50% solutions of the compositions prepared. The washing involved delivering 100 mg of the solution to the skin and rubbing the area with a glass rod 15 times. After a wait of about 45 seconds the area is rinsed with water and the area dried with a blower.

The material deposited on the area of the skin is removed using a cotton swab dipped in PEG-200. The material from the swab is then extracted with methanol and concentrated by evaporation, and then analyzed for deposition. The deposition efficiency is calculated as the percentage of benefit agent deposited on the skin after the washing procedure to the amount of benefit agent used on the skin in the washing solution. An average of 5 readings of deposition efficiency is taken to determine reproducibility.

The average deposition efficiency for the examples is listed in Table 2.

TABLE 2

| Examples | Deposition Efficiency |
|---|---|
| Comparative Example A | 2.3 |
| Comparative Example B | 3.7 |
| Comparative Example C | 4.4 |
| Comparative Example D | 1.0 |
| Comparative Example E | 2.3 |
| Example 1 | 14.0 |

The data in Table 2 indicates that there is synergistic improvement in deposition efficiency when the benefit agent is added to the cleaning composition through a functional oil-in-water emulsion, as compared to the known formulations containing benefit agent.

1. A cleansing composition capable of enhancing deposition of benefit agent comprising:
i. a functional oil-in-water emulsion comprising 0.1% to 5% by weight benefit agent solubilised/dispersed in an oil and emulsified in water using a cationic emulsifier having an HLB greater than 8 such that the ratio of oil:cationic emulsifier is in the range 20:1 to 1:1;
ii. a detergent active composition comprising 5% to 80% detergent active; and
iii. a cationic polymer.

2. A composition according to claim 1 wherein the benefit agent is selected from sunscreen, perfume or anti-bacterial agent.

3. A composition according to claim 1 wherein the cationic emulsifier has an HLB in the range of 13 to 18.

4. A composition according to claim 3 wherein the cationic emulsifier is chosen from the group of quaternary ammonium surfactant compounds.

5. A composition according to claim 1 wherein the ratio of the oil:cationic emulsifier is in the range of 10:1 to 1:1.

6. A composition according to claim 1 wherein the cationic polymer is selected from poly(diallyl dimethyl ammonium chloride), poly(dimethyl amino ethyl acrylate)-quaternized {DMAEA quat}, poly(dimethyl amino ethyl methacrylate)-quaternized {DMAEM quat}, or poly (methacrylamido propyl trimethyl ammonium chloride) {MAPTAC}, or mixtures thereof.

7. A composition according to claim 1 wherein the cationic polymer is present in an amount of 0.75% to 4.0%.

8. A composition according to claim 1 wherein the cationic polymer has a molecular weight in the range of 40 kg/mole to 5000 kg/mole.

9. A composition according to claim 8 wherein the cationic polymer has a molecular weight in the range of 200 kg/mole to 500 kg/mole.

10. A composition according to claim 1 wherein the cationic polymer has a charge density greater than 1 mEq/g.

11. A composition according to claim 10 wherein the cationic polymer has a charge density in the range of 5 to 6 mEq/g.

12. A composition according to claim 1 wherein the oil is selected from isopropyl myristate, isopropyl palmitate, silicone oil, or structured mineral oil, or mixtures thereof.

13. A composition according to claim 1 wherein the composition additionally comprises one or more of antioxidants, thickeners, polymers, fragrance, humectants, pH adjusters, preservatives, or essential oils.

14. A process for the preparation of a cleansing composition for enhanced delivery of benefit agents comprising the steps of:
(i) dispersing/dissolving the benefit agent in an oil by mixing;
(ii) preparing a functional oil-in-water emulsion by mixing the product of step (i) in water along with a cationic emulsifier;
(iii) mixing the functional oil-in-water emulsion with other ingredients to prepare a composition comprising the functional oil-in-water emulsion, a detergent active and a cationic polymer.

15. A process for the preparation of a cleansing composition according to claim 14 wherein the cationic polymer is mixed with the detergent active before it is mixed with the functional oil-in-water emulsion.
